(19) United States
(12) Patent Application Publication
(10) Pub. No.: US 2005/0119422 A1
(43) Pub. Date: Jun. 2, 2005

(54) Thermally curable, thixotropic mixtures containing carbamate and/or allophanate groups

(75) Inventors: Hubert Baumgart, Munster (DE); Sandra Hasse, Drensteinfurt (DE); Vincent Cook, Munster (DE)

Correspondence Address: BASF CORPORATION;ANNE GERRY SABOURIN, 26701 TELEGRAPH ROAD, SOUTHFIELD, MI, 48034-2442, US

(73) Assignee: BASF Corporation, Southfield, MI (US)

(21) Appl. No.: 10/511,057

(22) PCT Filed: Apr. 24, 2002
(86) PCT No.: PCT/EP02/04477

(51) Int. Cl. C08L 75/00

(52) U.S. Cl. 525/540

(57) ABSTRACT

Heat-curable thixotropic mixtures containing carbamate and/or allophanate groups, comprising (A) at least one oligomer and/or polymer selected from the group consisting of oligomers and polymers containing allophanate groups, carbamate groups, and carbamate and allophanate groups, and (B) at least one thixotropic agent selected from the group consisting of urea or urea derivatives preparable by reacting at least one amine and/or water with at least one polyisocyanate, with the proviso that the mixture in question, based on its solids, further comprises at least one silica as thixotropic agent (C), and contains the thixotropic agent (B) in an amount of from 0.1 to 5% by weight if the oligomers and polymers (A) contain no allophanate groups; processes for preparing the mixtures, and their use as coating materials, adhesives and sealing compounds.

The invention relates to novel heat-curable thixotropic mixtures containing carbamate and/or allophanate groups. The present invention further relates to processes for preparing the novel heat-curable thixotropic mixtures containing carbamate and/or allophanate groups. The present invention relates additionally to the use of the novel heat-curable thixotropic mixtures containing carbamate and/or allophanate groups as coating materials, adhesives and sealing compounds. The present invention relates in particular to the use of the novel heat-curable thixotropic coating materials containing carbamate and/or allophanate groups as clearcoat material, especially for producing clearcoats as part of multicoat color and/or effect coating systems.

Thixotropic materials and coating materials comprising them have been known for a long time.

The literature references EP 0 192 304 A1, DE 23 59 923 A1, DE 18 05 693 A1, WO 94/22968 and DE 27 51 761 C2 describe coating materials comprising urea and/or urea derivatives as thixotropic agents.

The literature references WO 97/12945 and farbe+lack, November 1992, pages 829 ff. describe coating materials comprising modified, hydrophilic or hydrophobic silicas as thixotropic agents. As an alternative, urea derivatives are also mentioned in passing in farbe+lack. The literature reference U.S. Pat. No. 4,169,930 A discloses reaction products of silica and amines for use in coating materials.

The use of thixotropic agents in coating materials is intended, inter alia, to allow comparatively thick paint films to be applied without disruptive running. Especially in the case of nonaqueous coating materials comprising a thixotropic agent based on urea derivatives, and at least at high solids contents, the resulting film surfaces are unsatisfactory in terms of their visual appearance (especially leveling and gloss) and, moreover, lead to coatings lacking “condensation resistance” (exhibiting blushing owing to water infiltration). Thixotropic agents based on silicas give coating materials which are likewise unsatisfactory in terms of leveling.

A key feature of thixotropic agents is that the viscosity of a coating material prepared using them depends on the flow history and/or that the thixotropic agents are pseudoplastic, i.e., the viscosity of the coating material decreases as the applied shear stress goes up. Starting from a baseline viscosity, the viscosity decreases under shear stress and returns only gradually to the initial level after the shear stress has been removed. A thixotropic gel, for example, liquefies as a result of input of mechanical energy (stirring or the like) and solidifies again only gradually after the end of the input of energy. Pseudoplastic or thixotropic properties are advantageous for paint processing. In particular, the tendency of a coating material to run on application at high wet-film thickness may be controlled and reduced. On the other hand, thixotropic agents must not adversely affect the optical and chemical properties of a finished coating produced using them. As a general rule, thixotropic agents are particulate and are present in dispersion in a coating material, whether aqueous or nonaqueous. In the case of the urea derivatives, these thixotropic agents are acicular crystals, in part with a helical twist, for which, preferably, a particle size distribution between 0.1 μm and 6 μm (95-99% of the particles, based on the volume) is established and 80% of the particles (based on the number) are smaller than 2 μm. In the case of the silicas, the fineness of grind in the finished coating material is typically less than 10 μm in accordance with DIN ISO 1524. The primary particle size of pyrogenic silicas is generally situated within the range from 5 to 20 nm.

Over time, the thixotropic agents known to date have been developed further in a variety of ways.

For instance, the German patent application DE 199 24 170 A1 discloses thixotropic agents preparable by reacting monoamines with specific polyisocyanates in the presence of, for example, hydroxyl-containing polyacrylates. The clearcoat materials in which they are present, applied by the wet-on-wet technique, give multicoat color and/or effect coating systems which, owing to the very good intercoat adhesion, exhibit no delamination, have outstanding optical properties, and show no blushing following exposure to condensation. The thixotropic agents and the thixotropic coating materials in question contain no carbamate and/or allophanate groups.

The German patent application DE 199 24 172 A1 discloses thixotropic agents comprising a mixture of silica and urea and/or urea derivatives. The urea derivatives are prepared by reacting monoamines with polyisocyanates in the presence of binders, such as hydroxyl-containing polyacrylates. The coating materials in question have a reduced tendency to run and are stable on storage. The clearcoats or multicoat color and/or effect coating systems produced from them are stable to condensation and have outstanding optical properties. Neither the thixotropic agents nor the coating materials contain carbamate and/or allophanate groups.

The German patent application DE 199 24 171 A1 discloses thixotropic agents comprising a mixture of at least one wetting agent (cf. Römpp Lexikon Lacke und Druckfarben, Georg Thieme Verlag, Stuttgart, New York, page 409, “Wetting agents”) and urea and/or urea derivatives and also, if desired, silicas. Here again, the urea derivatives are prepared by reacting monoamines with polyisocyanates in the presence of binders, such as hydroxyl-containing polyacrylates. The coating materials in question likewise have a reduced tendency to run and are stable on storage. Again, the clearcoats or multicoat color and/or effect coating systems produced from them are stable to condensation and exhibit very good leveling, have a very good surface smoothness, and have outstanding optical properties. Owing to the very good intercoat adhesion, there is no delamination of the coatings. Neither the thixotropic agents nor the coating materials contain carbamate and/or allophanate groups.

Coating materials comprising ingredients containing allophanate groups are known from the German patent application DE 198 39 453 A1. These coating materials are capable of wide application and are outstandingly suitable for the wet-on-wet technique for producing multicoat color and/or effect coating systems. The coatings produced from the coating materials are highly compatible with other coatings and are scratch-resistant and weathering-stable. Providing these known coating materials with thixotropic agents is not described in the German application.

The international patent application WO 00/31194 discloses thixotropic agents comprising urea derivatives and polymers containing lateral or terminal carbamate groups. The urea derivatives may be prepared by reacting monoamines with polyisocyanates in the presence of these polymers. The coating materials provided with the thixotropic agents may also comprise surface-active or interface-active substances (surfactants; cf. Römpp Lexikon Lacke und Druckfarben, Georg Thieme Verlag, Stuttgart, New York, page 271, “Surface-active substances”). According to example 1, page 23 line 22, of the international patent application, a silicone-glycol copolymer (Worlee® 315) is used. The thixotropic agents improve the thixotropic behavior of the coating materials provided with them and effectively suppress the tendency to run. The coatings produced from them exhibit high gloss and a high level of hardness. The thixotropic agents known from the international patent application do not include any silicas.

The German patent application DE 199 46 048 A1, unpublished at the priority date of the present specification, discloses coating materials whose binder comprises at least one resin containing lateral and/or terminal carbamate groups and preparable by reacting a resin containing at least one hydroxyl group with phosgene to give a resin containing at least one chloroformate group, which resin is then reacted with ammonia, primary amines and/or secondary amines. Apart from the customary and known crosslinking agents for heat curing, the coating materials may further comprise numerous different additives. For instance, besides numerous other additives, mention is made of transparent fillers based on silicon dioxide, aluminum oxide or zirconium oxide (for further details, refer to Römpp Lexikon Lacke und Druckfarben, Georg Thieme Verlag, Stuttgart, 1998, pages 250 to 252); sag control agents (thixotropic agents), such as ureas and/or modified ureas or silicas, as described for example in the aforementioned literature references EP 0 192 304 A1, DE 23 59 923 A1, DE 18 05 693 A1, WO 94/22968, DE 27 51 761 C2, WO 97/12945 and farbe+lack, November 1992, pages 829 ff.; and also wetting agents, such as siloxanes, fluorine compounds, carboxylic half-esters, phosphoric esters, polyacrylic acids and their copolymers, or polyurethanes. Precise details as to the amounts in which these additives are to be used are lacking. It is merely stated that the additives are added in customary and known, effective amounts, which depending on the additive are from 0.001 to 500 parts by weight per 100 parts by weight of resin and crosslinking agents. In the examples, however, these additives are not used.

The German patent application DE 199 61 926.3, unpublished at the priority date of the present specification, discloses compositions curable thermally and with actinic radiation (dual-cure compositions) which comprise at least one ingredient mandatorily containing on average per molecule at least one primary or secondary carbamate group and at least one bond which can be activated with actinic radiation. Apart from the customary and known crosslinking agents, the known dual-cure compositions may further comprise the abovementioned fillers, transparent fillers, and thixotropic agents. The dual-cure compositions may be used as coating materials, adhesives and sealing compounds.

The heat-curable thixotropic coating materials, adhesives and sealing compounds known to date and containing carbamate groups, especially the clearcoat materials, therefore have a number of technical advantages, which ought to be retained in the course of their further development. Despite the high technological level attained, the coatings, adhesive films and seals produced from the heat-curable thixotropic coating materials, adhesives and sealing compounds known to date and containing carbamate groups still leave something to be desired in terms of their stonechip resistance.

It is an object of the present invention to provide novel heat-curable thixotropic mixtures containing carbamate and/or allophanate groups that are suitable for use as coating materials, adhesives and sealing compounds, these compositions attaining the high technological level of the prior art, if not indeed exceeding it. Furthermore, the novel heat-curable thixotropic coating materials, adhesives and sealing compounds containing carbamate and/or allophanate groups should give coatings which attain the high technological level of the prior art, if not indeed exceeding it, and at the same time possess high stonechip resistance.

The invention accordingly provides the novel heat-curable thixotropic mixtures containing carbamate and/or allophanate groups, comprising
(A) at least one oligomer and/or polymer selected from the group consisting of oligomers and polymers containing allophanate groups, carbamate groups, and carbamate and allophanate groups, and
(B) at least one thixotropic agent selected from the group consisting of urea or urea derivatives preparable by reacting at least one amine and/or water with at least one polyisocyanate,
   with the proviso that the mixture in question, based on its solids,
   further comprises at least one silica as thixotropic agent (C), and
   contains the thixotropic agent (B) in an amount of from 0.1 to 5% by weight if the oligomers and polymers (A) contain no allophanate groups.

In the text below, the novel heat-curable thixotropic mixtures containing carbamate and/or allophanate groups are referred to as the “mixtures of the invention”.

Further subject matter, processes and uses in accordance with the invention will emerge from the description.

Here and below, polymers are understood to be substances containing on average per molecule at least 10 monomer units. Oligomers are understood to be substances containing on average per molecule from 3 to 15 monomer units. For further details of these terms, refer to Römpp Lexikon Lacke und Druckfarben, Georg Thieme Verlag, Stuttgart, New York, 1998, “Oligomers”, page 425.

In a first variant in accordance with the invention, the mixtures of the invention comprise at least one oligomer and/or polymer (A) selected from the group consisting of oligomers and polymers containing allophanate groups or allophanate groups and carbamate groups.

It is preferred to use oligomers and/or polymers (A) containing on average per molecule at least one allophanate group and preferably at least two, with particular preference at least three, and in particular at least four, allophanate groups.

It is likewise preferred to use oligomers and/or polymers (A) containing on average per molecule at least one allophanate group and at least one carbamate group and also, preferably, at least two, with particular preference at least three, and in particular at least four, allophanate groups and at least one carbamate group, in particular at least two carbamate groups.

The mixtures of the invention in accordance with the first variant comprise at least one thixotropic agent (B) selected from the group consisting of urea and urea derivatives preparable by reacting at least one amine and/or water, especially an amine, with at least one polyisocyanate, among which the urea derivatives are of advantage and are therefore used with preference.

Furthermore, the mixtures of the invention in accordance with the first variant may comprise at least one, especially one, silica as thixotropic agent (C).

The mixtures of the invention in accordance with the second inventive variant comprise at least one, especially one, oligomer and/or polymer (A) which is free from allophanate groups but contains carbamate groups, at least one thixotropic agent (B) and at least one thixotropic agent (C).

The oligomers and/or polymers (A) containing carbamate groups contain on average per molecule preferably at least one carbamate group and more preferably at least two, with particular preference at least three, and in particular at least four, carbamate groups.

The mixtures of the invention of the first and second inventive variant may further comprise at least one wetting agent (D).

The amount of the oligomers and polymers (A) in the mixtures of the invention may vary very widely and is guided by the requirements of the respective end use. Preferably, the mixtures of the invention contain the oligomers and polymers (A) in an amount, based in each case on the solids of the mixture of the invention, of from 10 to 98, more preferably from 12 to 95, with particular preference from 14 to 92, with very particular preference from 16 to 90, and in particular from 18 to 88% by weight.

Here and below, solids means the sum of the ingredients of the respective mixture of the invention which, following the heat cure, constitute the coatings, adhesive films or seals.

The amount of the thixotropic agents (A) in the mixtures of the invention may also vary very widely. It, too, is guided by the requirements of the respective end use. Preferably, the mixtures of the invention comprising oligomers and polymers (A) containing allophanate groups contain the thixotropic agents (B) in an amount, based in each case on the solids of the mixture of the invention, of from 0.1 to 5, more preferably from 0.2 to 4.5, with particular preference from 0.3 to 4, with very particular preference from 0.4 to 3.5, and in particular from 0.5 to 3% by weight. The mixtures of the invention comprising oligomers and polymers (A) which are free from allophanate groups necessarily have this amount of thixotropic agents (B).

The amount of the thixotropic agents (C) in the mixtures of the invention may likewise vary very widely. It, too, is guided by the requirements of the respective end use. Preferably, the mixtures of the invention contain the thixotropic agents (C) in an amount, based in each case on the mixture of the invention, of from 0.1 to 10, more preferably from 0.2 to 9, with particular preference from 0.3 to 8, with very particular preference from 0.4 to 7, and in particular from 0.5 to 6% by weight.

When used, the wetting agents (D) are present in the mixtures of the invention preferably in an amount, based in each case on the solids of the mixture of the invention, of from 0.01 to 5, more preferably from 0.02 to 4, with particular preference from 0.03 to 3, with very particular preference from 0.04 to 2, and in particular from 0.05 to 1% by weight.

Suitable oligomers and polymers (A) hail from the polymer classes of the random, alternating and/or block, linear and/or branched and/or comb, addition (co)polymers of ethylenically unsaturated monomers, or polyaddition resins and/or polycondensation resins. For further details of these terms, refer to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation” and “Polycondensation resins”.

Examples of highly suitable addition (co)polymers (A) are (meth)acrylate copolymers and partially saponified polyvinyl esters, especially (meth)acrylate copolymers.

Examples of highly suitable polyaddition resins and/or polycondensation resins (A) are polyesters, alkyds, polyurethanes, polylactones, polycarbonates, polyethers, epoxy resin-amine adducts, polyureas, polyamides or polyimides.

With very particular preference, the oligomers and/or polymers (A) hail from the polymer classes of the (meth)acrylate copolymers.

Oligomers and polymers (A) that contain allophanate groups and hail from the abovementioned polymer classes are known from the German patent application DE 198 39 453 A1, page 2 line 65 to page 6 line 34, and page 7 lines 25 to 53.

Oligomers and polymers (A) that contain carbamate groups and hail from the abovementioned polymer classes, and processes for preparing them, are known from the patent applications
EP 0 594 068 A1, page 2 line 45 to page 4 line 27, page 5 lines 36 to 57, and page 7 lines 1 to 22,
EP 0 594 142 A1, page 3 line 1 to page 4 line 37, page 5 line 49 to page 6 line 12, and page 7 lines 5 to 26,
EP 0 675 141 B1, page 2 line 44 to page 5 line 15, page 8 line 5 to page 10 line 41, and
WO 94/10211, page 4 line 18 to page 8 line 8, page 12 line 30 to page 14 line 36, page 15 line 35 to page 17 line 32, and page 18 line 16 to page 19 line 30 or are described in the German patent application
DE 199 46 048 A1, unpublished at the priority date of the present specification.

The oligomers and/or polymers (A) are preferably prepared by copolymerizing a monomer mixture containing at least one olefinically unsaturated carboxylic acid, methacrylic acid for example, in the presence of a glycidyl ester of Versatic® acid (cf. Römpp Lexikon Lacke und Druckfarben, Georg Thieme Verlag, Stuttgart, New York, 1998, “Versatic® acids”, pages 605 and 606) and then reacting the resultant hydroxyl-containing (meth)acrylate copolymer with at least one alkylurethane.

Preferably, the oligomers and polymers (A) have a number-average molecular weight of from 600 to 20 000, more preferably from 800 to 15 000, with particular preference from 1000 to 10 000, with very particular preference from 1200 to 8000 and in particular from 1200 to 6000 daltons.

The oligomers and polymers (A) may be rendered soluble in water or dispersible in water through the incorporation of dispersing groups. Examples of suitable dispersing groups are anion-forming groups, such as carboxylic acid, sulfonic acid or phosphonic acid groups, or anionic groups, such as carboxylate, sulfonate or phosphonate groups, cation-forming groups, such as primary, secondary or tertiary amino groups, or cationic groups, examples being ammonium groups, such as primary, secondary, tertiary or quaternary ammonium groups, sulfonium groups and phosphonium groups, or polyalkylene oxide groups, such as polyethylene oxide groups, which may be incorporated laterally, terminally and/or chain-internally into the oligomers and polymers (A) (cf. Römpp Lexikon Lacke und Druckfarben, Georg Thieme Verlag, Stuttgart, New York, 1998, “Water-dispersible binders”, page 619, and “Water-soluble binders” pages 626 and 625).

The thixotropic agents (B) are selected from the group consisting of urea and urea derivatives preparable by reacting at least one amine and/or water with at least one polyisocyanate, especially in the presence of at least one oligomer and/or polymer (A). It is preferred to use the urea derivatives. For their preparation, it is preferred to use the amines.

The amines are preferably selected from the group consisting of acyclic aliphatic, aliphatic-aromatic, cycloaliphatic, aliphatic-cycloaliphatic and cycloaliphatic-aromatic primary and secondary monoamines. Examples of suitable monoamines are known from the patent applications and patents cited at the outset, in particular from the German patent applications DE 199 24 172 A1, page 3 lines 3 to 10, or DE 199 24 171 A1, page 3 lines 35 to 42, or from the international patent application WO 00/31194, page 11 lines 14 to 29. Particular preference is given to using methoxypropylamine, benzylamine and/or n-hexylamine.

It is preferred to use polyisocyanates containing on average per molecule at least 1.8, preferably at least 2, and in particular 2 isocyanate groups. Examples of suitable polyisocyanates and diisocyanates are described in detail in the international patent application WO 00/31194, page 11 line 30 to page 12 line 26, or in German patent applications DE 199 24 172 A1, page 3 lines 11 to 23, DE 199 24 170 A1, column 3 line 61 to column 6 line 68, or DE 199 24 171 A1, page 3 line 43 to page 5 line 34. Particular preference is given to using hexamethylene diisocyanate and its oligomers, especially trimers.

The reaction of the amines or of water, especially the amines, with the diisocyanates takes place as described in German patent applications DE 199 24 172 A1, page 3 lines 22 to 27, and page 2 line 66 to page 3 line 2, or DE 199 24 171 A1, page 3 lines 25 to 34, or in the international patent application WO 00/31194, page 12 line 23 to page 13 line 19. For the preparation of the urea derivatives on the tonne scale, the process known from the German patent application DE 199 03 283 A1, in which an inline dissolver is used as the mixing unit, is advantageous.

The silicas used as thixotropic agents (C) are selected from the group consisting of modified pyrogenic, hydrophilic and hydrophobic, transparent silicas. Particular preference is given to using hydrophilic and hydrophobic pyrogenic silicon dioxides whose agglomerates and aggregates have a chainlike structure and which may be prepared by flame hydrolysis of silicon tetrachloride in an oxyhydrogen flame. They are sold, for example, by Degussa under the brand name Aerosil®. Particular preference is also given to using precipitated waterglasses, such as nanohectorites, which are sold, for example, by Südchemie under the brand name Optigel® or by Laporte under the brand name Laponite®. Further examples of suitable silicas are those known from the German patent application DE 199 24 172 A1, page 3 lines 28 to 32. A further example of suitable hydrophilic, transparent silicas is Aerosil® 380 having an internal surface area of 380 m²/g (measured in accordance with BET to DIN 66131).

The wetting agents (D) are selected from the group consisting of siloxanes, fluorine compounds, carboxylic half-esters, phosphates, polyacrylic acids and their copolymers, and polyurethanes. It is preferred to use polyurethanes. Particular advantages are possessed by the wetting agent (D) described in the German patent application DE 199 24 171 A1 from page 2 line 63 to page 3 line 24. Further highly suitable wetting agents are sold under the commercial designation Disperbyk® 361 by Byk, Borchigen® by Bayer AG, and Tego Disperse® 710 by Tego Chemie Services.

The mixtures of the invention may comprise at least one crosslinking agent containing on average per molecule at least two reactive functional groups which are complementary to carbamate groups and allophanate groups. In that case, the mixtures of the invention in question are externally crosslinking.

Alternatively to the crosslinking agents or additionally to them, it is possible to use oligomers and polymers (A) containing on average per molecule at least one, in particular at least two, reactive functional groups which are complementary to carbamate groups and allophanate groups. In that case, mixtures of the invention in question are partially or fully self-crosslinking.

Examples of suitable complementary reactive functional groups are N-methylol groups and N-methylol ether groups, preferably the methyl, ethyl, n-propyl and/or n-butyl ethers.

Furthermore, the oligomers and polymers (A) may contain further reactive functional groups which are able to undergo crosslinking reactions with complementary reactive functional groups other than those mentioned above. Examples of suitable reactive functional groups are isocyanate-reactive functional groups, such as thiol, hydroxyl and/or primary and/or secondary amino groups, especially hydroxyl groups, or epoxide-reactive groups such as the amino groups or carboxyl groups. It is preferred to use hydroxyl groups.

The amount of the further reactive functional groups in the oligomers and/or polymers (A) may vary very widely. Preferably, their hydroxyl number is from 20 to 120, more preferably from 25 to 110, with particular preference from 30 to 100, with very particular preference from 35 to 90, and in particular from 40 to 80 mg KOH/g. The acid number or amine number is preferably from 5 to 100, more preferably from 10 to 95, with particular preference from 15 to 90, with very particular preference from 20 to 85, and in particular from 25 to 80 mg KOH/g.

Accordingly, the crosslinking agents comprise amino resins, especially melamine resins, examples of suitable amino resins are described in Römpp Lexikon Lacke und Druckfarben, Georg Thieme Verlag, 1998, page 29, “Amino resins”, in the text book “Lackadditive” [Additives for coatings] by Johan Bieleman, Wiley-VCH, Weinheim, New York, 1998, pages 242 ff., in the book “Paints, Coatings and Solvents”, second, completely revised edition, edited by D. Stoye and W. Freitag, Wiley-VCH, Weinheim, New York, 1998, pages 80 ff., in the patents U.S. Pat. No. 4,710,542 A1 or EP 0 245 700 A1, and in the article by B. Singh and coworkers, “Carbamylmethylated Melamines, Novel Crosslinkers for the Coatings Industry”, in Advanced Organic Coatings Science and Technology Series, 1991, Volume 13, pages 193 to 207.

In addition to the above-described crosslinking agents it is possible to use further crosslinking agents, especially if the oligomers and/or polymers also contain the above-described further reactive functional groups. Examples of suitable further crosslinking agents are known from the German patent applications DE 199 24 170 A1, column 10 line 51 to column 12 line 68, DE 199 24 171 A1, page 7 line 38 to page 8 line 35 and page 8 lines 43 to 47, or DE 199 24 172 A1, page 5 line 22 to page 6 line 50 and page 6 lines 58 to 61. In particular, use is made of the blocked, part-blocked and unblocked polyisocyanates described therein. Part-blocked and unblocked polyisocyanates are used primarily in two-component or multicomponent systems.

The crosslinking agents are preferably present in the mixtures of the invention in an amount, based on the mixture of the invention, of from 5 to 70, more preferably from 10 to 65, with particular preference from 15 to 60, with very particular preference from 20 to 55, and in particular from 20 to 50% by weight. In this context it is further advisable to choose the amounts of crosslinking agents and oligomers and/or polymers (A) such that in the mixtures of the invention the ratio of reactive functional groups in the crosslinking agent and complementary reactive functional groups in the oligomers and/or polymers (A) is from 2:1 to 1:2, preferably from 1.5:1 to 1:1.5, with particular preference from 1.2:1 to 1:1.2, and in particular from 1.1:1 to 1:1.1. Furthermore, it is of advantage if the additional crosslinking agent is employed in smaller amounts than the crosslinking agent. Preferably, the proportion of crosslinking agent to additional crosslinking agent is 10:1, more preferably 8:1, with particular preference 6:1, with very particular preference 5:1, and in particular 4:1.

Apart from the ingredients described above, the mixtures of the invention may further comprise at least one additive.

In the case of pigmented mixtures of the invention, said mixtures comprise pigments and fillers selected from the group consisting of customary and known organic and inorganic color and/or effect, electrically conductive, magnetically shielding and fluorescent pigments and customary and known organic and inorganic fillers other than the thixotropic agents (C).

These pigments and fillers are used if the mixtures of the invention are used as pigmented adhesives and sealing compounds and also coating materials, such as primer-surfacers, basecoat materials or solid-color topcoat materials.

Additives which may be used both in the pigmented and in the unpigmented mixtures of the invention are known from the German patent applications DE 199 24 170 A1, column 13 line 6 to column 14 line 2, or DE 198 39 453 A1, page 6 line 68 to page 7 line 6, with the exception here of the wetting agents and the transparent fillers based on silicon dioxide.

Further examples of suitable additives are oligomers and/or polymers which are free from carbamate and/or allophanate groups, which hail from the above-described polymer classes, especially the class of (meth)acrylate copolymers, and which contain the above-described additional reactive functional groups, especially hydroxyl groups. Suitable oligomers or polymers are described in detail in the patent applications mentioned above relating to the oligomers and polymers (A) or in the German patent application DE 139 08 018 A1, page 9 line 31 to page 11 line 37. Particularly advantageous are the (meth)acrylate copolymers which contain in copolymerized form alkyl (meth)acrylates selected from the group consisting of 2- and 3-propyl (meth)acrylate and 3- and 4-n-butyl (meth)acrylate.

The preparation of the mixtures of the invention has no special features in terms of its method but instead takes place by the mixing of the above-described ingredients (A) and (B) or (A), (B) and (C) and also, if desired, of the above-described crosslinking agents and/or additives. This may be done using mixing units such as stirred tanks, dissolvers, inline dissolvers, stirred mills, static mixers, toothed-wheel dispersers or extruders.

Depending on their end use, the mixtures of the invention may be present in organic solvents as solutions and/or dispersions (nonaqueous dispersions, NADs) or as substantially or entirely solvent-free mixtures. The substantially or entirely solvent-free mixtures may be present in liquid form (100% system) or powder form. Furthermore, the mixtures of the invention may be present in solution or dispersion in water. Not least, the pulverulent mixtures of the invention may be present in the form of dispersions in water, as what are known as powder slurries. Preferably, the mixtures of the invention are present in dispersion and/or solution in organic solvents.

The mixtures of the invention are outstandingly suitable as dual-cure coating materials, adhesives and sealing compounds, or for preparing them. The coating materials of the invention are outstandingly suitable for the production of single-coat or multicoat, color and/or effect, electrically conductive, magnetically shielding or fluorescent coatings, such as primer-surfacer coats, basecoats or solid-color topcoats, or of single-coat or multicoat clearcoat systems. The adhesives of the invention are outstandingly suitable for the production of adhesive films, and the sealing compounds of the invention are outstandingly suitable for the production of seals.

Very particular advantages result when the mixtures of the invention are used as clearcoat materials to produce single-coat or multicoat clearcoat systems. In particular, the clearcoat materials of the invention are used to produce multicoat color and/or effect coating systems by the wet-on-wet technique, in which a basecoat material, especially an aqueous basecoat material, is applied to the surface of a substrate, after which the resultant basecoat film is dried, without being cured, and is overcoated with a clearcoat film. Subsequently, the two films are cured together.

In terms of its method, the application of the coating materials, adhesives and sealing compounds of the invention has no special features but may instead take place by any customary application method, such as spraying, knifecoating, brushing, flowcoating, dipping, trickling, or rolling, for example. In the context of the coating materials of the invention it is preferred to employ spray application methods, such as compressed air spraying, airless spraying, high-speed rotation, electrostatic spray application (ESTA), for example, alone or in conjunction with hot spray applications such as hot air spraying, for example.

Suitable substrates are all those whose surface is undamaged by the application of heat in the course of the curing of the films present thereon. The substrates consist preferably of metals, plastics, wood, ceramic, stone, textile, fiber composites, leather, glass, glass fibers, glass wool, rockwool, mineral- and resin-bound building materials, such as plasterboard and cement slabs or roof tiles, and also composites of these materials.

Accordingly, the coating materials, adhesives and sealing compounds of the invention are suitable not only for applications in the fields of automotive OEM finishing and automotive refinish but are also appropriate for the coating, bonding and sealing of buildings, inside and out and of doors, windows and furniture, for industrial coating, including coil coating, container coating and the impregnation and/or coating of electrical components, and for the coating of white goods, including domestic appliances, boilers and radiators. In the context of industrial coatings, they are suitable for coating, bonding or sealing virtually all parts and articles for private or industrial use, such as domestic appliances, small metal parts such as nuts and bolts, hub caps, wheel rims, packaging, or electrical components, such as motor windings or transformer windings.

In the case of electrically conductive substrates it is possible to use primers which are produced in a customary and known manner from electrodeposition coating materials. For this purpose both anodic and cathodic electrodeposition coating materials are suitable, but especially cathodic electrodeposition coating materials. Unfunctionalized and/or nonpolar plastics surfaces may be subjected, prior to coating in a known manner, to a pretreatment, such as with a plasma or by flaming, or may be provided with a water-based primer.

The curing of the applied mixtures of the invention also has no special features in terms of its method but instead takes place in accordance with the customary and known thermal methods, such as heating in a forced air oven or irradiation using IR lamps.

The resultant coatings of the invention, especially the single-coat or multicoat color and/or effect coating systems and clearcoats of the invention, are easy to produce and exhibit outstanding optical properties and very high light stability, chemical resistance, water resistance, condensation resistance, and weathering stability. In particular, they are free from turbidities and inhomogeneities. Moreover, they are hard, flexible and scratch-resistant. They exhibit outstanding intercoat adhesion between basecoat and clearcoat and good to very good adhesion to customary and known automotive refinishes.

The adhesive films of the invention permanently and firmly join a very wide variety of substrates to one another and possess high chemical and mechanical stability even in the case of extreme temperatures and/or temperature fluctuations.

Similarly, the seals of the invention seal substrates permanently, and exhibit high chemical and mechanical stability even in the case of extreme temperatures and/or temperature fluctuations and even in conjunction with exposure to aggressive chemicals.

In particular, however, the coatings of the invention possess a high stonechip resistance, and so may be used with particular advantage in the field of automotive coatings.

Accordingly, the primed or unprimed substrates commonly employed in the technological fields recited above and coated with at least one coating of the invention, bonded with at least one adhesive film of the invention and/or sealed with at least one seal of the invention combine a particularly advantageous profile of performance properties with a particularly long service life, so making them particularly attractive economically.

### EXAMPLES

### Preparation Example 1

The Preparation of a Methacrylate Copolymer (A) Containing Carbamate Groups

A reactor equipped with a stirrer, an oil heating system, two dropping funnels, a nitrogen inlet pipe, a thermometer and a reflux condenser was charged with 326.1 parts by weight of methyl carbamate, 489.8 parts by weight of xylene and 482.6 parts by weight of Cardura® E 10 (glycidyl ester of Versatic® acid from Shell) and this initial charge wad heated to 140° C. with stirring. After the initial charge had reached this temperature, a monomer mixture of 434.6 parts by weight of hydroxymethyl methacrylate, 119 parts by weight of styrene and 163.6 parts by weight of methacrylic acid was added over the course of three hours and an initiator solution of 72 parts by weight of Vazo® 67 (2,2′-azobis[2-methylbutanone nitrile] from Du Pont) and 181.9 parts by weight of xylene was added over three hours, both additions to the initial charge taking place at a uniform rate. The two feed streams were commenced simultaneously. After the end of the feed streams, the reaction mixture was cooled to 115° C. over 30 minutes. Thereafter, an initiator solution of 12.1 parts by weight of 2,2′-azobis[2-methylbutanone nitrile] and 36.9 parts by weight of xylene was metered into the reaction mixture over the course of one hour, after which the reaction mixture was held at 115° C. for a further hour. Following the addition of 2.8 parts by weight of Fascat® 4100 (monobutyltin oxide from Atochem) in 31.3 parts by weight of cyclohexane, the reaction mixture was heated to 140° C. with stirring and was held at this temperature until the hydroxyl number was 77 mg KOH/g solids. Subsequently, the reaction mixture was cooled to 100° C. and diluted with 25 parts by weight of methyl isobutyl ketone and 125 parts by weight of xylene. Unreacted methyl carbamate and the cyclohexane were removed by vacuum distillation at 130° C. until the methyl carbamate content was <2% by weight. After cooling to 80° C., the reaction mixture was diluted with 125 parts by weight of methoxypropanol. The resultant solution of the methacrylate copolymer (A) containing carbamate groups had a solids content of 70% by weight (60 minutes forced air oven/130° C.), an acid number of from 1 to 4 mg KOH/g solids and a color number of from 4 to 5 (Gardner).

### Preparation Example 2

The Preparation of the Solution of a Thixotropic Agent (B)

In a reactor, 814 parts by weight of the methacrylate copolymer solution (A) from preparation example 1 were mixed with 96 parts by weight of Solventnaphtha® and 19.6 parts by weight of benzylamine. Under vigorous stirring, a mixture of 15.4 parts by weight of hexamethylene diisocyanate and 35 parts by weight of Solventnaphtha® was added. The resultant reaction mixture was stirred for a further 15 minutes. The solution of the thixotropic agent (B) had a solids content of 60% by weight (60 minutes forced air oven/130° C.).

### Preparation Example 3

The Preparation of a Thixotroping Paste (C)

A stirred laboratory mill from Vollrath was charged with 800 g of millbase consisting of 592 parts by weight of the methacrylate copolymer solution (A) from preparation example 1, 80 parts by weight of butyl acetate, 64 parts by weight of xylene and 64 parts by weight of Aerosil® 972 (average primary particle sizes: 16 nm; BET surface area to DIN 6613 1:110±20 m²/g; Degussa AG, Hanau) together with 1100 parts by weight of quartz sand (grain size 0.7-1 mm) and dispersed for 30 minutes with water cooling. Subsequently, the quartz sand was separated off.

### Preparation Example 4

The Preparation of a Blocked Polyisocyanate (Additional Crosslinking Agent)

A suitable stainless steel reactor was charged with 40 parts by weight of Basonat® HI 190 B/S (isocyanurate based on hexamethylene diisocyanate, from BASF Aktiengesellschaft) and 16.4 parts by weight of Solventnaphtha® and this initial charge was heated to 50° C. Over the course of four hours, 26.27 parts by weight of diethyl malonate, 6.5 parts by weight of ethyl acetoacetate and 0.3 parts by weight of catalyst solution (sodium ethylhexanoate) were metered in at a uniform rate. Thereafter, the temperature was raised to 70° C. When an isocyanate equivalent weight of 5900 to 6800 was reached, 1.03 parts by weight of 1,4-cyclohexanedimethanol were added over the course of 30 minutes at 70° C. with stirring. After an isocyanate equivalent weight of ≧13 000 had been reached, 5 parts by weight of n-butanol were added. The temperature of the reaction mixture was lowered to 50° C. and the resultant blocked polyisocyanate was diluted with n-butanol to a theoretical solids content of 68% by weight.

### Example 1

The Preparation of an Inventive Clearcoat Material

The inventive clearcoat material was prepared by mixing and homogenizing the following ingredients:
206 parts by weight of the methacrylate copolymer solution (A) from preparation example 1,
207 parts by weight of the solution of the thixotropic agent (B) from preparation example 2,
41 parts by weight of the thixotroping paste (C) from preparation example 3,
55 parts by weight of the blocked polyisocyanate from preparation example 4,
5 parts by weight of Disperbyk® 161 (30 percent strength solution of a commercial wetting agent, from Byk Chemie),
128 parts by weight of Resimene® BM-9539 (commercial methyl- and butyl-etherified melamine resin from Monsanto),
10 parts by weight of Tinuvin® 384 (commercial UV absorber from Ciba Specialty Chemicals, Inc.),
8 parts by weight of Tinuvin® 123 (commercial reversible free-radical scavenger, sterically hindered amine (HALS) from Ciba Specialty Chemicals, Inc.),
20 parts by weight of Nacure® 5528 (commercial catalyst (amine-blocked sulfonic acid derivative) from King),
2 parts by weight of Silwet® L-7604 (commercial additive from Witco Surfactants),
31 parts by weight of butyl diglycol acetate,
37 parts by weight of xylene,
47 parts by weight of Solvesso® 200,
153 parts by weight of Solventnaphtha®, and
31 parts by weight of butyl glycolate.

Using the mixture of the abovementioned solvents, the clearcoat material was adjusted to a viscosity of 25 seconds in the DIN 4 flow cup. It then had a solids content of 48% by weight (one hour forced air oven/130° C.).

### Example 2

The Production of an Inventive Multicoat Color Coating System

To produce the multicoat system, steel test panels coated with an electrodeposition coating in a dry film thickness of from 18 to 22 μm were coated with a waterborne primer-surfacer. The resultant waterborne primer-surfacer film was baked at 160° C. for 20 minutes to give a primer-surfacer coat with a dry film thickness of from 35 to 40 μm. The primer-surfacer coat was subsequently coated with a black aqueous basecoat material from BASF Coatings AG in a film thickness of from 12 to 15 μm. The resultant aqueous basecoat films were flashed off at 80° C. for 10 minutes. Thereafter, the clearcoat material from example 1 was applied pneumatically using a gravity-feed gun in one cross-pass in a film thickness of from 40 to 45 μm. Subsequently, the clearcoat films were flashed off at room temperature for 10 minutes and at 80° C. for 10 minutes and together with the aqueous basecoat films were baked in a forced air oven at 140° C. for 20 minutes.

For the leveling test, the clearcoat material was electrostatically applied vertically and horizontally to the test panels. This was done using an Eco-bell with direct charging. The leveling was assessed visually as being particularly good. This is underscored by the measurement of the wave-scan values, which is familiar to the skilled worker:
longwave/shortwave at 40 μm, horizontal application: 4.7/10.6
longwave/shortwave at 40 μm, vertical application: 7/7.9
   (Instrument: Byk/Gardner—wave-scan plus).

In order to test for the tendency to run, customary and known perforated metal sheets were used instead of the test panels. Basecoat and clearcoat were baked in vertical position. Initial signs of runs occurred only at clearcoat thicknesses >50 μm; the runs reached a length of 1 cm only at 60 μm.

The resultant multicoat system was highly brilliant and had a gloss (20°) to DIN 67530 of 91.

The scratch resistance was assessed with the aid of the sand test (cf. German patent application DE 138 39 453 A1, page 9 lines 1 to 63). Following damage at room temperature a loss of gloss of only 18 units (20°) was found, which underlined the high scratch resistance.

The chemical resistance was determined with the aid of the gradient oven test to DaimlerChrysler PBODDC371, which is known in the art. A note was made of the temperatures above which the applied chemicals left visible damage in the multicoat systems. In the case of sulfuric acid, damage was noted only at 61° C., which underlines the chemical resistance.

1. A heat-curable thixotropic mixture containing allophanate groups comprising
(A) at least one oligomer and/or polymer that contains at least one allophanate group or contains at least one carbamate group and at least one allophanate group, and
(B) at least one thixotropic agent comprising a urea or a urea derivatives prepared by reacting at least one amine and/or water with at least one polyisocyanate.

2. The mixture of claim 1, wherein the at least one oligomers and/or polymer contain at least one allophanate group and further comprises a thixotropic agent (C) comprising at least one silica.

3. The mixture of claim 1, further comprising (D) at least one wetting agent.

4. The mixture of claim 1, wherein the at least one of the oligomer and the polymer are each at least one of an addition (co)polymer of at least one ethylenically unsaturated monomer, a polyaddition resin, and a polycondensation resin, wherein the addition (co)polymer is at least one of a random (co)polymer, an alternating (co)polymer, and a block (co)polymer, and wherein the addition (co)polymer is at least one of linear, branched, and comb.

5. The mixture of claim 4, wherein the addition (co)polymer is selected from the group consisting of (meth)acrylate copolymers and polyvinyl esters, and the polyaddition resin and polycondensation resins are each selected from the group consisting of polyesters, alkyds, polyurethanes, polylactones, polycarbonates, polyethers, epoxy resin-amine adducts, polyureas, polyamides, and polyimides.

6. The mixture of claim 1, wherein the at least one amines is selected from the group consisting of acyclic aliphatic amines, aliphatic-aromatic amines, cycloaliphatic amines, aliphatic-cycloaliphatic amines and cycloaliphatic-aromatic amines, wherein the at least one amine is a primary monoamine or a secondary monoamines.

7. The mixture of claim 6, wherein the monoamine is selected from the group consisting of methoxypropylamine, benzylamine, and n-hexylamine.

8. The mixture of claims 1, wherein the at least one polyisocyanates contains on average per molecule at least 1.8 isocyanate groups.

9. The mixture of claims 1, wherein the at least one polyisocyanates is selected from the group consisting of hexamethylene diisocyanate and its oligomers.

10. The mixture of claims 2, wherein the silica is a transparent silica selected from the group consisting of modified pyrogenic silicas, hydrophilic silicas, and hydrophobic silicas.

11. The mixture of claims 3, wherein the at least one wetting agents (D) is selected from the group consisting of siloxanes, fluorine compounds, carboxylic half-esters, phosphates, polyacrylic acids, copolymers of polyacrylic acids, and polyurethanes.

12. The mixture of claims 1, further comprising at least one crosslinking agent containing on average per molecule at least two reactive functional groups which are complementary to allophanate groups.

13. The mixture of claim 1, wherein the at least one of the oligomers and the polymer each contain on average per molecule at least one reactive functional group which is complementary to carbamate groups and allophanate groups.

14. The mixture of claim 13, wherein the complementary reactive functional groups are selected from the group consisting of N-methylol groups and N-methylol ether groups.

15. The mixture of claims 1, further comprising a crosslinking agents selected from the group consisting of blocked polyisocyanates, partially-blocked polyisocyanates, and unblocked polyisocyanates.

16. A process for preparing the heat-curable thixotropic mixture of claim 1 comprising
I) mixing of the at least one oligomer and/or polymer (A) and the thixotropic agent (B), and optionally a silica, or
II) preparing the thixotropic agent (B) by reacting the at least one amine with the at least one polyisocyanate in the presence of the at least one oligomer and/or polymer (A), and optionally mixing in a silica.

17. The mixture of claim 1, wherein the mixture is one of a coating material, an adhesive, or a sealing compound.

18. The material of claim 17, wherein the coating material is a clearcoat material.

19. A method comprising applying the mixture of claim 17 to a substrate and forming one of an automotive OEM finish, an automotive refinish, a buildings coating, a furniture coating, a window coating, a door coating, an industrial coating, a coil coating, a container coating, an electrical component impregnation, an electrical component coating, or a white goods coating.
